(19) United States
(12) Patent Application Publication
(10) Pub. No.: US 2021/0192861 A1
(43) Pub. Date: Jun. 24, 2021

(54) METHOD AND APPARATUS FOR INTER-VEHICULAR SAFETY AWARENESS AND ALERT

(71) Applicant: FORD GLOBAL TECHNOLOGIES, LLC, Dearborn, MI (US)

(72) Inventors: Manoharprasad K. RAO, Novi, MI (US); Kwaku O. PRAKAH-ASANTE, Commerce Twp., MI (US); Mark A. CUDDIHY, New Boston, MI (US)

(21) Appl. No.: 17/195,331

(22) Filed: Mar. 8, 2021

Related U.S. Application Data
(62) Division of application No. 15/185,833, filed on Jun. 17, 2016.

(51) Int. Cl. G07C 5/00; G07C 5/08

(52) U.S. Cl. CPC G07C 5/006; G07C 5/0816; G07C 5/0808; G07C 5/008

(57) ABSTRACT

A system includes a processor configured to detect an operating condition of a first vehicle based on at least one sensor of a second vehicle in communication with the processor. The processor is also configured to wirelessly broadcast the operating condition or associated alert including any vehicle identifying traits of the first vehicle as detected by the second-vehicle sensor or other detection systems of the second vehicle.

### CROSS-REFERENCE TO RELATED APPLICATIONS

This application is a division of U.S. application Ser. No. 15/185,833 filed Jun. 17, 2016, the disclosure of which is hereby incorporated in its entirety by reference herein.

### TECHNICAL FIELD

The illustrative embodiments generally relate to a method and apparatus for inter-vehicular safety awareness and alert.

### BACKGROUND

Most vehicles undergo periodic safety inspections and are equipped with alert functions controlled by system sensors that can inform an owner/driver when a vehicle system is experiencing a malfunction. Other times, a passing driver may flash lights to indicate a low tire pressure state or obstruction hanging off of a vehicle undercarriage. Sometimes undetectable by vehicle sensors, these degradations are not catastrophic, but they can lead to difficult driving conditions. Other vehicle systems, such as a headlight or brake light, may fail and go undetected by a driver until an inspection occurs or a police officer pulls the vehicle over. Systems such as lights often do not have their own sensors included therewith.

Since identification of many vehicle maintenance and repair issues relies on human observation, these issues may often go unnoticed until an inspection is performed. Even then, if the technician is not explicitly made aware of the problem, the problem may still go unnoticed. These undetected system maintenance and repair issues can lead to increased driver costs in the form of added maintenance and driving citations.

### SUMMARY

In a first illustrative embodiment, a system includes a processor configured to detect a local-vehicle malfunction, detected by a monitoring-vehicle sensor in communication with the processor. The processor is also configured to wirelessly broadcast the local-vehicle malfunction, including any local-vehicle identifying traits detected by the monitoring-vehicle sensor or other monitoring-vehicle detection systems.

In a second illustrative embodiment, a system includes a processor configured to receive a malfunction report from a first vehicle, including malfunction data for a second vehicle observed by a sensor of the first vehicle and identification data of the second vehicle. The processor is also configured to determine a specific identity of the second vehicle based on the identification data. The processor is further configured to determine if wireless connection credentials are available for the specifically identified second vehicle. Also, the processor is configured to utilize available connection credentials to establish wireless communication with the second vehicle and report the data over the wireless communication.

In a third illustrative embodiment, a system includes a processor configured to receive a diagnostic broadcast, including diagnostic data and associated vehicle identification data, from a broadcasting vehicle. The processor is also configured to determine if the identifying data identifies a receiving vehicle including the processor and to alert a driver of the receiving vehicle of the diagnostic data if the identifying data identifies the receiving vehicle.

### BRIEF DESCRIPTION OF THE DRAWINGS

FIG. 1 shows an illustrative vehicle computing system;

FIG. 2 shows an illustrative example of a recognition and notification system;

FIG. 3 shows an illustrative example of a recognition and notification process;

FIG. 4 shows a further example of a recognition and notification process;

FIG. 5 shows an illustrative example of alert connection request handling; and

FIG. 6 shows an illustrative example of an alert connection process.

### DETAILED DESCRIPTION

As required, detailed embodiments are disclosed herein; however, it is to be understood that the disclosed embodiments are merely illustrative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

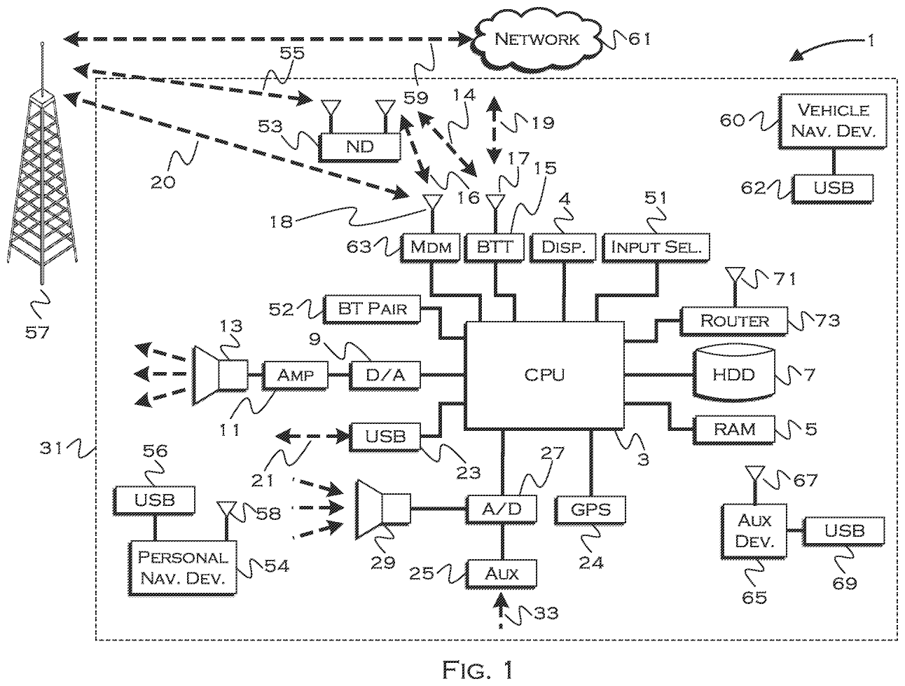

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and a system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, a representative, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Modern vehicles are being equipped with advanced active safety and vehicle connectivity systems. In the near future, a large number of vehicles will be equipped with advanced surround sensing systems, such as, but not limited to, radar, lidar and vision sensor systems. These systems will use sensor fusion techniques to get a better understanding of host vehicle surrounding environments. In the case of highly automated vehicles and fully automated vehicles, the capabilities of the surround sensing systems may even exceed those of the human drivers.

While travelling on the roads, drivers may notice some vehicles in front of them operating in an unsafe mode endangering the vehicle occupant safety and the safety of other road users around them. For example, a vehicle's lights may be off during inclement weather, or the vehicle brake lights may not be working properly, (the brake lights or the third back light may be out). In addition, the rear tires may be loose and wobbling excessively, the rear tires may be under inflated or flat. In most of these situations, the driver of the malfunctioning vehicle may not be aware of the state of the malfunction. The illustrative embodiments present a system to categorize surrounding vehicle conditions automatically, by recognizing various vehicle conditions using advanced surround sensing systems, and provide feedback to the affected vehicles through local and remote connectivity.

The illustrative embodiments categorize vehicle conditions in passing vehicles and facilitate corrective recommendation guidance measures through wireless and cloud-connected services. Multiple vision systems may be used to scan around the vehicle. The vision systems that look in the forward direction will have high resolution and processing capabilities to provide various features/capabilities such as lane departure warning/lane keep aid, traffic sign recognition, license plate recognition etc.

These forward looking vision sensors can be expected to have capabilities to detect the back lights, tires and exhaust systems of the vehicles ahead of them. It is reasonable to assume that the forward looking vision systems will have sensing capabilities similar to a human driver for proximate vehicle review. Similarly, for vehicles coming in the opposite direction, malfunctioning states may include, but are not limited to, low tire pressure in front tires, wobbling front tires, malfunctioning front lights, improperly closed hood etc. may be communicated to the defective vehicle operator using vehicle-to-vehicle and/or other vehicle connectivity systems.

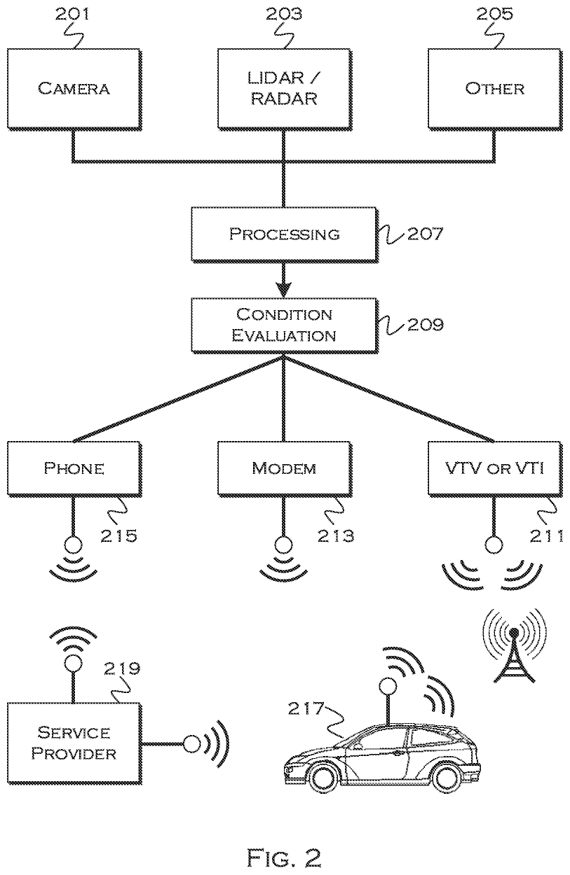

FIG. 2 shows an illustrative example of a recognition and notification system. Referred to as a surrounding vehicle condition recognition and categorization system, the system learns and tracks partner vehicle condition and driving behavioral inconsistencies and can assign risk levels to observations. The information is sent to connected services to provide feedback to the partner vehicle owner or other remote site.

Vehicles may be highly connected and equipped with systems, such as vehicle-to-vehicle (VTV) communication systems, vehicle-to-infrastructure (VTI) communications (which connect to roadside antennas and can access other vehicles as well as other information about the roadway), modems which can be connected wirelessly (cloud connected) to both a centralized service provider, and to authorities, such as local traffic enforcement, emergency services, etc. The vehicle may also be equipped with systems, such as the FORD SYNC system, which can communicate directly with the vehicle occupants and also communicate with remote service providers via modems and/or by connecting with mobile devices brought into the vehicle by the vehicle occupants.

A vehicle which is equipped with appropriate surround sensing systems (vision sensors 201, radar 203, lidar 203, and other sensing systems 205) can use those sensing systems to detect a variety of conditions in surrounding vehicles. Radar and lidar can detect speeds and odd behavior (swerving, wobbling tires, etc.). Vision system cameras can detect light outages, low tire states, tire wobble, unexpected lane departures and general unexpected deviances in vehicle appearance, indicative of a knowable malfunction.

The data gathered from the sensor suites can be fed into a processing engine 207 (or, in another example, can be off-boarded to a cloud server for processing). A condition evaluation system 209 can work in conjunction with the processing engine, to receive filtered, parsed and sorted results from the sensors and to determine which conditions may be represented by the gathered sensor data. If a monitoring vehicle is capable of specifically identifying a proximate malfunctioning vehicle (such as by license plate recognition, or more generally by make, model, color, size, type, etc), the monitoring vehicle may attempt to connect to the malfunctioning vehicle or initiate a broadcast including the identified malfunction along with any noted vehicle identifying features (e.g., “the vehicle with license plate AAA 1111 has a brake-light out” or “the black SUV has a low left-rear tire”).

If a local vehicle 217 can be identified sufficiently to request a direct communication connection, a local transceiver 211 can be used to attempt to communicate the malfunction information with the local vehicle. This same transceiver (which can be, for example, without limitation, Wi-Fi, BLUETOOTH, BLE, etc) can also be used to simply broadcast information about any identified malfunctions, for receipt by appropriately equipped passing vehicles.

In other examples, the monitoring vehicle may communicate via an onboard modem 213 or through an occupant phone 215 to connect to a remote system 219. The remote system can receive malfunction reports, provide access information (addresses, keys, permissions, etc) for identified local vehicles, and even relay reports to local vehicles if VTV communication is deemed undesirable for some reason. In this manner, a monitoring vehicle can identify numerous defects or malfunctions in surrounding vehicles and unobtrusively notify the driver's of those vehicles while the monitoring vehicle travels. Further, there is less confusion for the receiving driver than, for example, if a passing human driver had simply flashed lights at the receiving driver to indicate a problem. At the same time, the monitoring vehicle can act without any interaction needed by its own driver, increasing the driver's ability to focus on the task of driving. And, because the sensor suites may be more highly observant than a driving human, a higher likelihood of identifying presently existing minor undesirable conditions is achieved.

A monitoring vehicle equipped with VTV communication capability may notify the defective vehicle about the malfunctioning features. The defective vehicle may communicate that information to the vehicle operator using vehicle audio or visual systems or via email to the vehicle operator mobile device or computer, for example. The vehicle which observed the malfunctioning state of the other vehicle and which is equipped with a modem may communicate the license plate number of the vehicle (for a vehicle which has a license plate mounted in the back), time, location and information about the malfunctioning state to a central service provider and/or to transportation service related authorities who have access to the vehicle license plate information. Centralized service providers and traffic safety related authorities may contact the vehicle owner and inform the owner about any noted malfunctions.

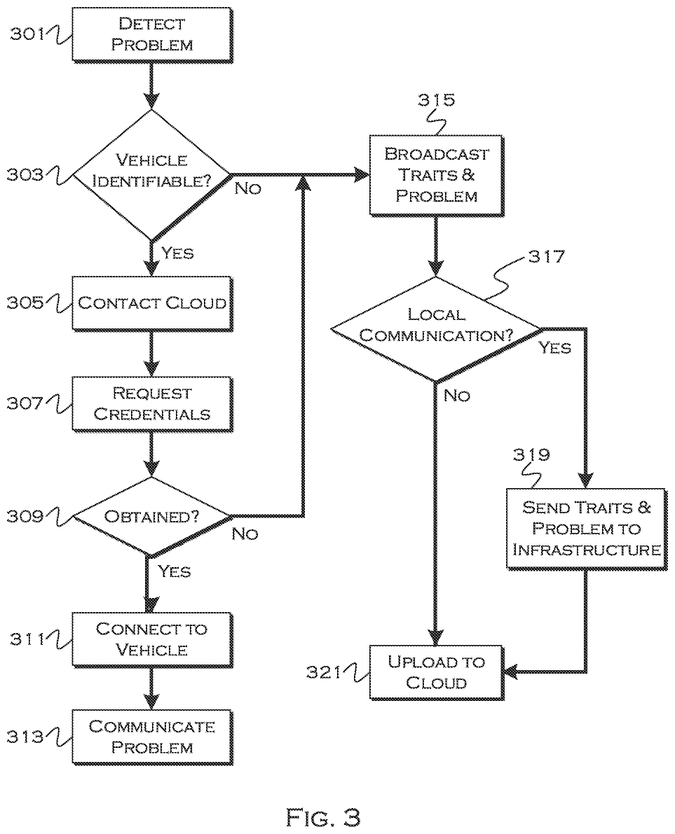

FIG. 3 shows an illustrative example of a recognition and notification process. In this illustrative embodiment, a monitoring vehicle detects a problem in a surrounding vehicle 301. This can include, for example, detection of low tire pressure, light out condition, unexpected lane deviance, piece of metal hanging or dragging, vehicle tilted or off-axis, vehicle swerving, etc. The detection can be made through any number of sensors, including, but not limited to, vision detection sensors, lidar, radar, etc.

If the vehicle is not identifiable in a manner that a direct transmission request can be obtained 303, the process may proceed to a broadcast of any identification information and/or noted malfunctions. For example, a camera may sense that the vehicle is black and an SUV, but no specific identification (e.g., without limitation, license plate) usable to directly identify the specific vehicle may be available. In such an instance, the process may use a local wireless transmission (Wi-Fi, BLE, BT, etc.) to broadcast the identified problem 315 along with any potentially useful vehicle identifying information.

It is also possible that a local communication relay (such as, for example a dedicated short range communication (DSRC)) relay may be locally available for vehicle communication. If such local communication is available 317, the process may broadcast the alert to the local relay 319. This can allow the local infrastructure to relay the message some number of hops in either direction for re-broadcast, which increases the likelihood of the message reaching the identified vehicle. This can be useful if the malfunctioning vehicle moves out of broadcast range of the monitoring vehicle before broadcast of the malfunction and identifying information can be made.

Also, if a communication connection with the cloud is available, the process can connect to a remote server for upload of information 321. This connection can include, for example, communicating the information with an original equipment manufacturer (OEM) server, communicating the information with an emergency services (PSAP) provider or authorities (for example, if a severe and dangerous defect is noted), or contacting any other suitable remote party.

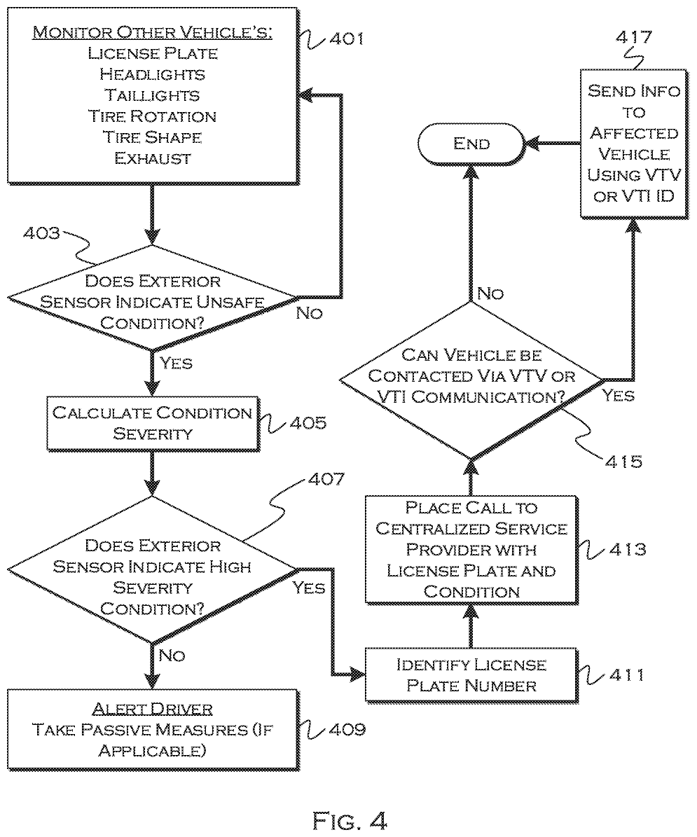

FIG. 4 shows a further example of a recognition and notification process. In this example, the process proceeds to monitor 401, for example, other vehicle license plates (for identification), headlights, taillights, tire rotation, tire shape, exhaust and exhaust characteristics, etc. The monitoring persists while an evaluation process determines if the exterior sensor(s) indicate a likely problem 403.

If a problem exists, in this example, a condition severity or priority is determined. For example, if a vehicle is noted to have almost-full tires or deviates from a lane once, a low priority notification may be assigned. A vehicle observed to be traveling at night with one or more lights out and a low tire while swerving, for example, may be assigned a high priority or emergency notification. If a high priority condition exists 407, the process will identify a license plate number 411 or other characteristics, and initiate contact with a PSAP or police to relay identifying characteristics and the noted condition or likely condition 413. If the malfunctioning vehicle can be directly contacted 415, the process may also send 417 the information directly to the local vehicle so the driver knows about the condition.

If the observed operating condition is a low-priority issue, the process may simply try to contact the local vehicle 409. Other passive measures may also be taken including flashing lights or providing other human-detectable indicia in the event that the local vehicle may not be contacted. The driver of the monitoring vehicle may also be notified, since there are many examples where this driver could pull alongside or park next to the malfunctioning vehicle and verbally notify the driver of the malfunctioning vehicle of the noted issue.

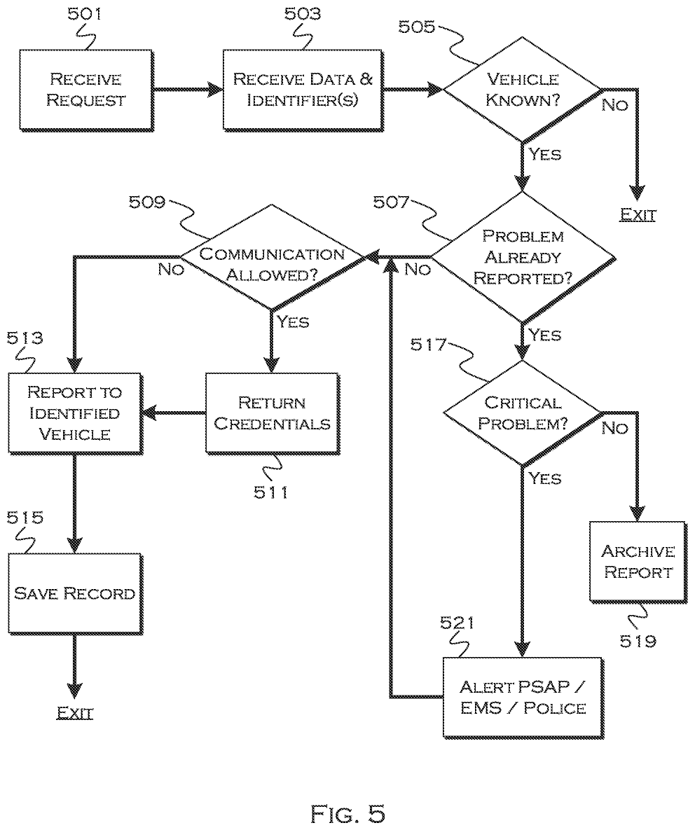

FIG. 5 shows an illustrative example of alert connection request handling. This illustrative process demonstrates an example of a process that might occur on a backend server, both to record any noted malfunctions and to facilitate delivery of the malfunction information to a malfunctioning vehicle. The process receives a request 501 from a monitoring vehicle for connection credentials for a locally identified malfunctioning vehicle. The server executing the process could be a generalized server provided to facilitate general VTV communication or could be an OEM server, which may be better suited for OEM-specific model-to-model communication.

In conjunction with the communication request, the process receives an identification of the problem or condition, associated data and any vehicle identifying information 503 (which can include, but it not limited to, make, model, type, color, license plate or other identifying features).

The remote process executes a database lookup to determine if the identified vehicle is also known to a system executing the process. For example, an OEM server may have connection credentials for any OEM-specific vehicles on the road, which are also equipped with V2V communication. Since the OEM server can act as a relatively secure pass-between, the server can establish temporary connection credentials with the identified vehicle (through direct communication with the malfunctioning vehicle) before passing the credentials to the requesting vehicle, so that only temporary VTV communication can be achieved. In other examples, if the malfunctioning vehicle owner does not wish VTV communication, the OEM server can relay the malfunction information to the malfunctioning vehicle (being a more trusted source than another vehicle).

If the malfunctioning vehicle is known 505, the process will also determine if the problem or condition has already been reported 507. This can include communicating with the malfunctioning vehicle to determine this information or determining if a database record for the problem already exists, for example. If the vehicle is not known to the OEM or other connection credential providing server, the process exits.

If the problem has been reported, the process will determine the associated priority or importance and whether the problem is reported as critical 517 (the analysis having been done on-board the monitoring vehicle). Determining priority or importance of a problem can be based on a set of predefined conditions. For example, if a tire appears to be low on air, the shape of the tire as seen by a camera can be compared to a proper shape to determine if the tire is critically low or somewhat deflated. Similar standards for categorizing identified conditions can be established for various types of malfunctions detected by monitoring vehicle sensors. If the problem is classified as low priority, the OEM server archives the report 519, but declines to provide VTV communication credentials, since the non-critical problem has already been reported at least once. In other examples, the condition for reporting may be include whether the condition has been most recently reported within a specified time period, or a specified number of times before changing the priority or importance associated with the notification. In another example, the vehicle owner may mark or designate particular priorities for conditions, or may designate specified conditions as being silenced or ignored for reporting to the vehicle, etc.

If the problem is classified as a high priority or critical issue, an alert may be issued to a PSAP or other emergency services provider or police 521.

If the problem has not been reported previously, or after an alert has been issued to assistance authorities in the case of a previously reported critical problem, the process may then determine if the malfunctioning driver will permit VTV communication. This can include checking a setting through vehicle communication or stored on the server that could limit communication entirely, limit communication to critical alerts, limit communication to non-redundant critical alerts, etc.

If the driver permits communication corresponding to the identified condition 509, the process may send connection credentials to the requesting vehicle 511. This can include, for example, a password or key, and may also include a password or key that is invalid after the report is issued to the vehicle or a time period expires. Also, in this example, the remote process reports the problem to the vehicle directly 513, if possible, to provide some redundancy in case the requesting vehicle has already moved out of communication range with the malfunctioning vehicle. A record of the report is also saved 515. In other examples, the relay of information from the remote OEM system may occur instead of providing the connection credentials (for example, if VTV communication is denied). In a further example, the relay of information may be utilized if the requesting vehicle later reports back that it was unable to use the VTV credentials to send malfunction information to the malfunctioning vehicle.

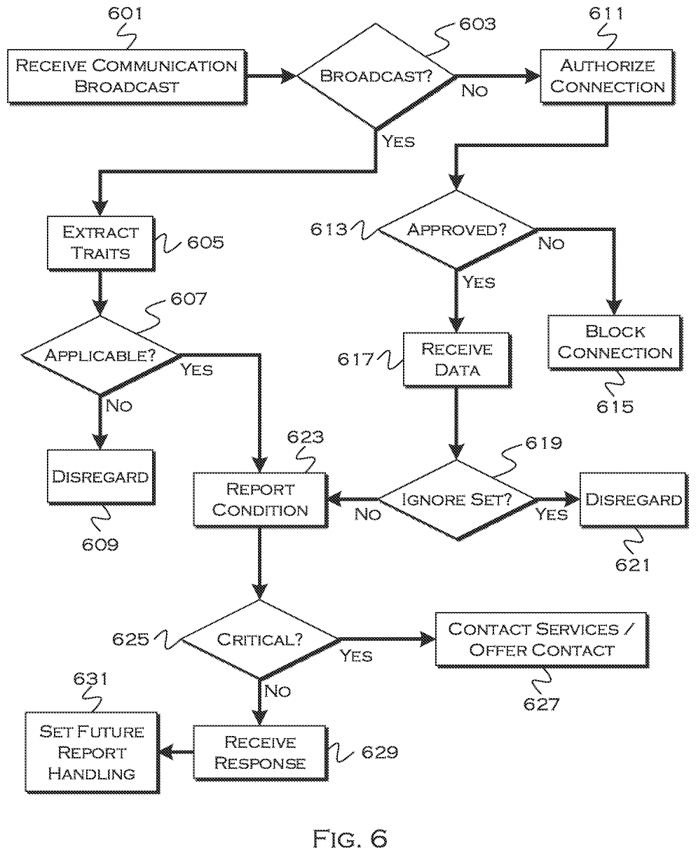

FIG. 6 shows an illustrative example of an alert connection process. In this example, a vehicle with a maintenance, repair, or other operating condition or issue may periodically or persistently listen for vehicle alert broadcasts. Listening may include waiting for indicia of a broadcast or providing an open channel over which broadcast data packets can be received, without establishing direct communication between two vehicles.

At some point in time, the process will receive a communication packet, which could result from a broadcast or direct VTV communication request. If a broadcast is received 603, the process will extract any vehicle identifying traits included in the broadcast 605. The process examines the traits and compares them to known vehicle traits. For example, if a red sedan receives a broadcast that a black SUV has a low tire pressure state, the red sedan will not correspond to the black SUV traits (being neither black nor an SUV) and the broadcast will be disregarded 609. Alternatively, if a black SUV (or possibly even a dark blue SUV) receives such a broadcast, the process may report the identified condition to the driver 623.

Speed and/or heading information may also be used as identifying traits, especially for local broadcasts, to help avoid confusion if there are numerous vehicles matching a generalized description. For example, the identification could be “a black SUV heading North East at 30 miles per hour.” This can help black SUVs to which this detection could not possibly apply to disregard the broadcast.

If the reported condition, which could be presented via an in-vehicle display or audio system or sent to a driver's phone, is a critical condition 625 as determined by the local malfunctioning vehicle or included in the report, the process can either contact emergency services or offer such contact as a driver selectable option 627. This can include contact of government emergency services, medical emergency services or even local mechanic or dealer assistance.

If the condition is non-critical, the process will receive a response from the driver 629 in this example, which can include setting an ignore-state to ignore future alerts of the same nature, setting a maintenance reminder, sending the information to the cloud, or other alert handling, pertaining to one or both of the present and/or future alerts relating to the same condition. Future handling of alerts relating to the same condition will be controlled by the response input by the driver 631. In another example, predefined handling may be saved with respect to a vehicle based on alert priority or importance. A low-priority or non-critical alert may be presented once or periodically based on mileage or elapsed time if re-detected, as compared to high-priority or critical alerts that may be persistently presented, etc.

Although it is not necessary that the driver respond to the alert, if a large number of vehicles are equipped with monitoring systems, the driver may wish to respond to confirm receipt of the alert and disregard the alert for some time period or until the problem is fixed, for example. This prevents the driver from being constantly alerted regarding the same problem. Predefined driver settings may also control alert-handling. For example, the driver may set a “receive then block” state whereby any alert is received once and then notification is blocked for a time period or indefinitely. Other reasonable iterations of driver settings for handling alerts are also contemplated.

In another example, the monitoring vehicle may include its own connection credentials in a communication broadcast. For example, if the monitoring vehicle determines that a local vehicle with license plate AAA-111 has an identified condition, but the monitoring vehicle may not want to broadcast the actual malfunction, the monitoring vehicle may broadcast an invitation to connect to the monitoring vehicle for further information. For example, the monitoring vehicle may broadcast a message identifying a vehicle with license plate AAA-111 and invite communication with MAC address 01-23-45-67-89-ab for additional information.

The malfunctioning vehicle can attempt to establish communication based on the provided MAC address to receive further information. Such connection data can be included regardless of the other contents of the broadcast to allow faster VTV communication to be established. Since a monitoring vehicle may be able to specifically or generally identify a proximate malfunctioning vehicle but have no means of requesting direct communication, providing such a broadcast would allow the malfunctioning vehicle to self-identify based on vehicle identifying traits included in the broadcast and establish communication with the monitoring vehicle.

As noted above, if the communication received by the malfunctioning vehicle is not a broadcast 603, then the process executing on the malfunctioning vehicle treats the communication as a direct request to connect to that specific vehicle. The process may authorize the connection 611 as previously described or through use of credentials obtained by the monitoring vehicle. Unauthorized communication requests that lack proper credentials or are otherwise undesirable 613 can be blocked 615.

If the connection is approved 613, VTV communication can occur between the monitoring vehicle and the malfunctioning vehicle. Relevant malfunction and/or identification data can be received by the malfunctioning vehicle 617. If an “ignore” flag is set for the data 619, which may occur when the malfunction is non-critical and has already been reported, the process can disregard the data 621 and end the connection. Otherwise, the process proceeds with reporting the condition 623.

Through the illustrative embodiments, vehicles can be used to detect minor conditions in surrounding vehicles that could eventually lead to much larger problems. By providing early notification detectable by drivers of the malfunctioning vehicles, alerts of reasonable specificity and quality can be delivered to the appropriate parties before more serious conditions arise.

While illustrative embodiments are described above, it is not intended that these embodiments describe all possible forms of the invention. The words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

1. A system comprising:
a processor configured to:
wirelessly receive an operating condition alert and detected vehicle identification data for a first vehicle broadcast from a second vehicle including condition data for the first vehicle detected by sensors of the second vehicle and included in the broadcast;
determine a vehicle-specific identity based on the identification data based on comparison of the detected identification date to a record of a plurality of vehicles including stored identification data for the plurality of vehicles;
establish wireless communication with the first vehicle using wireless connection credentials for the specifically identified first vehicle retrieved from the record for the determined vehicle-specific identity; and
report the condition data over the wireless communication.

2. The system of claim 1, wherein the processor is further configured to provide the wireless connection credentials to the second vehicle, responsive to a connection credential request from the second vehicle.

3. The system of claim 1, wherein the processor is further configured to determine if the condition data corresponds to a pre-identified critical condition; and
report a determined critical condition to emergency services.

4. The system of claim 1, wherein the processor is further configured to:
determine if the condition data corresponds to a previously reported condition;
determine a driver defined action for handling previously reported conditions, set by the driver of the first vehicle; and
handle the condition data in accordance with the driver-set action.

5. The system of claim 1, wherein the identification data includes at least one of a vehicle make or model.

6. The system of claim 1, wherein the identification data includes a license plate image or number.

7. The system of claim 1, wherein the identification data includes vehicle color.

8. A method comprising:
wirelessly receiving an operating condition alert and detected vehicle identification data for a first vehicle broadcast from a second vehicle including condition data for the first vehicle detected by sensors of the second vehicle and included in the broadcast;
determining a vehicle-specific identity based on the identification data based on comparison of the detected identification date to a record of a plurality of vehicles including stored identification data for the plurality of vehicles;
establishing wireless communication with the first vehicle using wireless connection credentials for the specifically identified first vehicle retrieved from the record for the determined vehicle-specific identity; and
reporting the condition data over the wireless communication.

9. The method of claim 8, further comprising providing the wireless connection credentials to the second vehicle, responsive to a connection credential request from the second vehicle.

10. The method of claim 8, further comprising determining if the condition data corresponds to a pre-identified critical condition; and
reporting a determined critical condition to emergency services.

11. The method of claim 8, further comprising:
determining if the condition data corresponds to a previously reported condition;
determine a driver-defined action for handling previously reported conditions, set by the driver of the first vehicle; and
handle the condition data in accordance with the driver-set action.

12. The method of claim 8, wherein the identification data includes at least one of a vehicle make or model.

13. The method of claim 8, wherein the identification data includes a license plate image or number.

14. The method of claim 8, wherein the identification data includes vehicle color.

15. A non-transitory storage medium storing instructions that, when executed, cause a processor to perform a method comprising:
wirelessly receiving an operating condition alert and detected vehicle identification data for a first vehicle broadcast from a second vehicle including condition data for the first vehicle detected by sensors of the second vehicle and included in the broadcast;
determining a vehicle-specific identity based on the identification data based on comparison of the detected identification date to a record of a plurality of vehicles including stored identification data for the plurality of vehicles;
establishing wireless communication with the first vehicle using wireless connection credentials for the specifically identified first vehicle retrieved from the record for the determined vehicle-specific identity; and
reporting the condition data over the wireless communication.

16. The storage medium of claim 15, the method further comprising providing the wireless connection credentials to the second vehicle, responsive to a connection credential request from the second vehicle.

17. The storage medium of claim 15, the method further comprising determining if the condition data corresponds to a pre-identified critical condition; and
reporting a determined critical condition to emergency services.

18. The storage medium of claim 15, the method further comprising:
determining if the condition data corresponds to a previously reported condition;
determine a driver-defined action for handling previously reported conditions, set by the driver of the first vehicle; and
handle the condition data in accordance with the driver-set action.

19. The storage medium of claim 15, wherein the identification data includes at least one of a vehicle make or model.

20. The storage medium of claim 15, wherein the identification data includes a license plate image or number.
